(19) United States
(12) Patent Application Publication
(10) Pub. No.: US 2010/0127460 A1
(43) Pub. Date: May 27, 2010

(54) SEALS WITH INTEGRATED LEAK DETECTION CAPABILITY

(75) Inventor: Barton E. Bennett, South Bend, IN (US)

Correspondence Address: BAKER & DANIELS LLP, 202 South Michigan Street, Suite 1400, South Bend, IN, 46601, US

(73) Assignee: ODYSSIAN TECHNOLOGY, LLC, South Bend, IN (US)

(21) Appl. No.: 12/324,153

(22) Filed: Nov. 26, 2008

(51) Int. Cl. F02F 11/00

(52) U.S. Cl. 277/313; 277/592

(57) ABSTRACT

In one embodiment of the invention, a seal device is provided with integrated leak detection capability for detecting the initiation of a leak of a contained fluid and includes a seal member having at least one sealing contact surface and a sensing member located on the sealing contact surface, the sensing member detecting if a breach has occurred in a seal formed between the sealing contact surface and a member against which the sealing contact surface is sealed to provide an indication of the breach before a complete breach of the seal occurs; and a deposit of electrically conductive particulates on the seal member located between the contained fluid and the sensing member.

### BACKGROUND OF THE INVENTION

The present invention pertains to a multifunctional gasket or seal that provides integrated leak detection functionality. Some examples of use include seals in containment and transfer systems having hazardous or environmentally damaging fluids, seals for mechanical devices having refrigerant, coolant, lubricating or fuel fluids, and seals for structure that provides separation of dissimilar material phase, environmental, or energy state.

Known fluid seals are made of a variety of materials and have a multitude of design configurations that include, but are not limited to, (i) a circular conformable elastomeric O-ring seated in a channel (gland) of a metallic or plastic fitting, (ii) circular washer made of soft conformable metallic or plastic material, (iii) flat gasket of various flat pattern made with conformable fibrous, cellulous, particulate, or polymeric material, (iv) circular compression fittings with off-set tapered mating surfaces, (v) circular flared fittings with conformable flared tubings, and (vi) circular threaded pipe fittings with off-set tapers, etc.

It is known that sealing using conformable materials is achieved when such material is placed between relatively rigid mating surfaces and that sealing occurs when the material displaces to conform to and fill the space between the mating surfaces.

It is also known that sealing of relatively rigid mating surfaces is achieved when such surfaces are in full or partial and often tight contact. Examples of such sealing are compression fittings and threaded pipe fittings that often have tapered mating surfaces that are offset to create tight contact during rotational tightening.

Presently, leak detection is achieved using a multitude of devices that are external and separate from the fluid containment structure and seal. Such devices include, but may not be limited to: (i) stationary chemical detection alarms, (ii) handheld portable chemical detection sensors, and (iii) handheld portable sonic emission detectors. Other means for leak detection include the use of foaming agents (soap) and dye that provide visual identification of a leak.

It is also known that leaks may be identified through the use of pressure sensors that measure fluid pressure within the containment system. Such systems typically measure bulk fluid pressure using a single pressure sensing device. Other means for direct indication of a leak include the use of temperature sensors that measure fluid temperature within the containment system. Such systems typically measure localized temperature at a specific location within the system using a single temperature sensing device. Fluid leakage can be identified by a corresponding increase in temperature readings.

Typical leak detection methods and devices identify leaks after leakage has occurred outside the fluid containment structure. One new type of seal that provides leak detection and leak progression detection before leakage has occurred outside of the fluid containing structure is disclosed in U.S. Pat. No. 7,316,154 B1 to Benneft, which is incorporated in its entirety herein by reference.

Bennett discloses multifunctional seals including sensors and sensor circuitry between each seal. The seals also include a power source and may include embedded electronics within a central core region. Seals are constructed to detect fluid leak progression using redundant sealing and sensors located between each set of seals to allow for the detection of leak propagation prior to leakage outside the sealed containment or transfer structure. Seal members are disclosed and the seals may include a pliable sealing material mounted to the seal member.

### BRIEF SUMMARY OF THE INVENTION

In one embodiment of the invention, a seal device is provided with integrated leak detection capability for detecting the initiation of a leak of a contained fluid and includes a seal member having at least one sealing contact surface and a sensing member located on the sealing contact surface, the sensing member detecting if a breach has occurred in a seal formed between the sealing contact surface and a member against which the sealing contact surface is sealed to provide an indication of the breach before a complete breach of the seal occurs; and a deposit of sense enabling material on the seal member located between the contained fluid and the sensing member.

The sense enabling material can be: a material that alters the electrical performance or property of a sensing member; or a material that alters the performance or property of the contained fluid to allow it to be detected; or a material connected to the sensing circuit whose electrical property is changed by the contained fluid.

The seal member can be a header or other gasket, the sense enabling material can be reactive particulates that are mixed with a binder material for deposition on the seal member, and the binder material may break down upon contact with the contained fluid. In one embodiment, the contained fluid carries the electrically conductive particulate solution into contact with the sensing member to detect the initiation of a leak of the seal as made possible by detecting the resulting change in conductivity in the sensing member or the change in conductivity in the space or separating material located between at least two electrical conductors.

The seal member can be a header or other gasket, the sense enabling material can be reactive particulates that are mixed with a binder material for deposition on the seal member, and the binder material may break down upon contact with the contained fluid. In one embodiment, the contained fluid carries the reactive particulate solution into contact with the sensing member or an electrical conductor to detect the initiation of a leak of the seal as made possible by detecting the resulting change in conductivity in the sensing member or the change in conductivity in the space or separating material located between at least two electrical conductors, or the change in conductivity of at least on electrical conductor that occurs due to corrosion or material alteration resulting from being in contact with the reactive particles within the sense enabling material.

In another embodiment, the binder material is removed, while leaving the conductive or reactive particulates, prior to installation of the seal member.

In yet another embodiment, the conductive or reactive particulates are mixed with a fluid media prior to deposition on the seal member. The fluid media can be evaporated from the seal member prior to installation.

The sensing member may include at least two concentric or closely spaced electric conductors, and the conductive particulates within the sense enabling material may cause a short circuit or closed switch between the electric conductors when carried by the contained fluid. The conductive particulates may be placed in close proximity to the electric conductors upstream in the direction of fluid flow, or the conductive particulates may be placed between the electric conductors.

In another embodiment of the invention, a method of obtaining a seal with integrated leak detection capability for detecting the initiation of a leak of a contained fluid is provided that includes the steps of providing a fluid carrying member for containing the fluid and a sealing contact face on the fluid carrying member configured to form a seal with another member; providing a seal member, including a contact face configured to seal against the contact face of the fluid carrying member, and a sensing member located on the contact face of the seal member; providing a deposit of sense enabling material on the contact face of the seal member; forming a seal between the sealing contact surfaces of the seal member and the contact face of the fluid carrying member, wherein when the seal is intact, the sensing member and the deposit of sense enabling material are not in contact with the contained fluid in the fluid carrying member; and sensing the initiation of a leak of the seal by the contained fluid carrying the sense enabling material into contact with the sensing member.

The sense enabling material can include conductive or reactive particulates/mixture. The method of obtaining a seal with integrated leak detection capability may also include the steps of providing a binder and mixing the binder with the conductive or reactive particulates for deposition on the seal member. The binder material may break down upon contact with the contained fluid. The conductive or reactive particulates may be carried by the contained fluid to contact the sensing member to detect the initiation of leak of the seal.

The method of providing a seal with integrated leak detection capability may also include the steps of providing a fluid media and mixing the fluid media with the conductive or reactive particulates prior to deposition on the seal member. The fluid media may be evaporated from the seal member prior to installation.

The sensing member may include at least two concentric or adjacent electric conductors, wherein the conductive particulates may cause a short or closed circuit between the concentric or adjacent electric conductors when carried by the contained fluid.

The sensing member may include at least one electric conductor or sensing member, wherein the sense enabling material may cause a change in electrical performance or property of the electric conductor or sensing member as can be caused through corrosion or material alteration of the electric conductor or sensing member when reactive particulates are carried by the contained fluid into contact with the electric conductor or sensing member.

### BRIEF DESCRIPTION OF THE DRAWINGS

The above-mentioned and other features and objects of this invention and the manner of obtaining them will become more apparent and the invention itself will be better understood by reference to the following description of embodiments of the present invention taken in conjunction with the accompanying drawings, wherein:

FIG. 1 is a perspective view of one embodiment of a seal device having integrated leak detection capability in accordance with the subject invention;

FIG. 1A is a cross sectional view of the seal device of FIG. 1 taken along line 1A-1A;

FIG. 2 is a perspective view of an alternate embodiment seal device;

FIG. 2A is an enlarged view of the area indicated in FIG. 2; and

FIG. 3 is a plan view of a cylinder block for which the seal device of FIG. 2 may be used in conjunction to form a seal.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

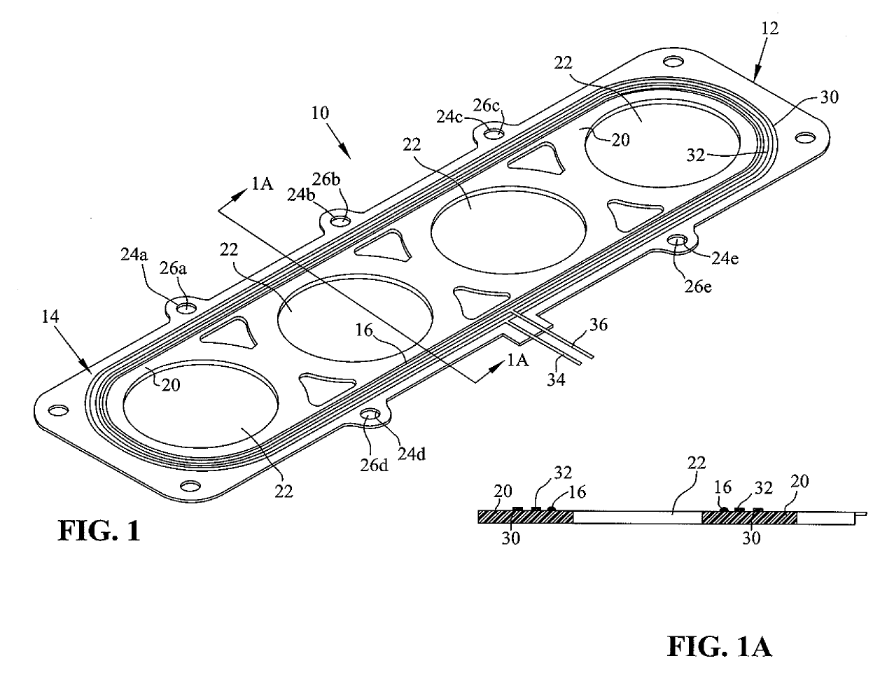

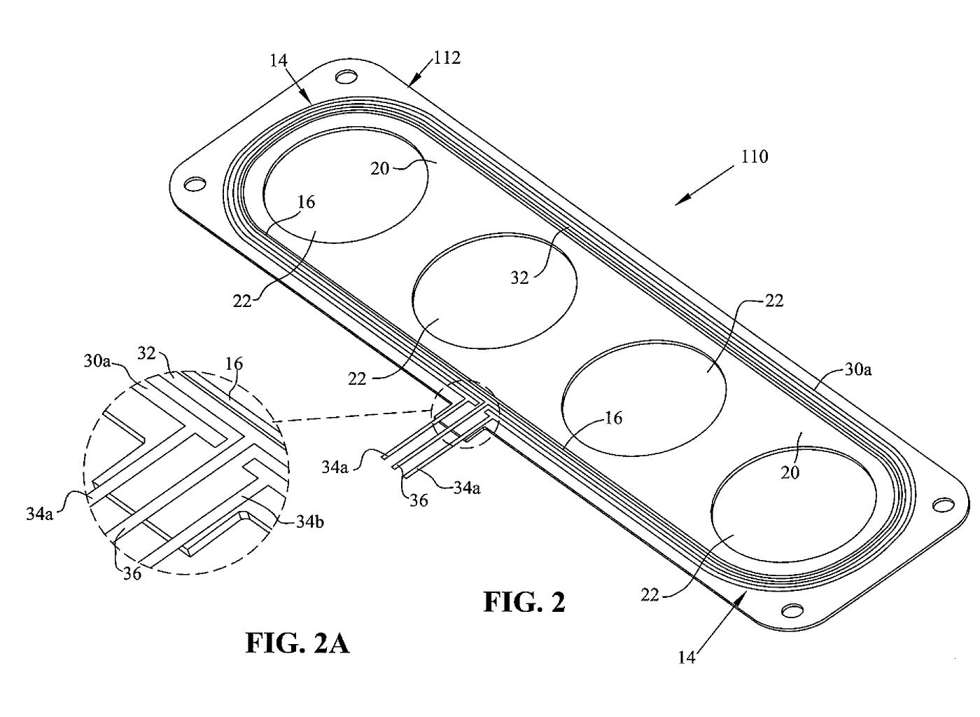

Referring now to FIGS. 1 and 2, one embodiment of a seal device, in accordance with the subject invention, is generally indicated as 10. Seal device 10 includes a seal member, generally indicated as 12; a sensing member, generally indicated as 14; and a deposit of electrically conductive or chemically reactive particulates, solution, and/or mixture, generally indicated as 16, and reference to particulates in this application shall include any form of conductive or chemically reactive material.

In the embodiment shown, seal member 12 is a member having the configuration of a head gasket made of elastomeric, cellulose, metallic, or other sealing material of known art. It should be appreciated, however, that seal member 12 may take on any desirable sealing configuration, including O-rings, washers, grommets, other gaskets, or fittings. Seal member 12 may be made from a single piece flexible member or may include a laminated design consisting of a compliant seal mounted on a more rigid backing plate or member. It should also be appreciated, for purposes more fully set forth below, that seal member 12 has a dielectric contact surface or includes a dielectric coating in the area of sensing member 14.

Seal member 12 also includes a sealing contact face 20, a plurality of openings 22, corresponding with cylinder bores for holding a contained fluid and a plurality of mounting flanges 24a-e, including bolt openings 26a-e, respectively, for mounting the head gasket 12 between a cylinder head (not shown) and cylinder block.

In the embodiment shown, sensing member 14 includes two concentric electric conductors 30 and 32, which are located on sealing contact face 20 and electrically separated from one another. It should be appreciated that electric conductors 30 and 32 may be applied with any known method including, but not limited to, using electrically conductive foils, printed conductive inks or compounds, or vapor metal deposition. Furthermore, device 12 includes a pair of electrical leads 34 and 36 to provide an electric current to electric conductors 30 and 32, respectively. It should be appreciated that an insulator, insulative coating, or other means to prevent electric contact must be provided where electric lead 36 crosses electric conductor 30.

Electrically conductive or chemically reactive particulates 16 are deposited on contact face 20 and concentric with electric conductors 30 and 32. Conductive or reactive particulates 16 are located between electric conductors 30, 32 and cylinder openings 22. The conductive particulates can include small particles of any electrically conductive material, such as copper, aluminum, silver, gold, carbon, or carbon nano materials. The reactive particulates can include small particles of any chemically reactive material, including, but not limited to, reactive ions, oxidants, acidic materials, caustic materials. The conductive or chemically reactive materials can be mixed with a binder for depositing the particles onto seal member 12. The binder may be made from a material that is soluble in the contained fluid, for reasons set forth below, or alternately, the binder may be removed after depositing the particulates. and print a conductive or reactive ink onto seal member 12. The fluid media can then be evaporated away prior to installation of the seal member.

Referring now to FIG. 2, an alternate embodiment seal device is generally indicated as 110. Seal device 110 is similar in most respects to seal device 10. However, seal device 10 includes a seal member 112 with a slightly different configuration. In addition, seal device 110 includes an outer electric conductor 30A which is split about electric lead 36, as best shown in FIG. 2A. In addition, seal device 110 includes a pair of electric leads 34a and 34b connected to the ends of conductor 30a on either side of lead 36.

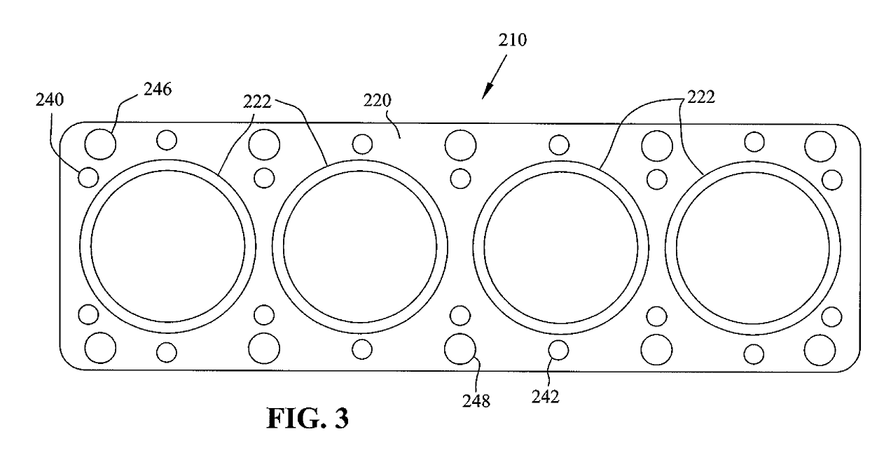

Referring now to FIG. 3, a cylinder block is shown, generally indicated as 210. Cylinder block 210 includes a sealing contact face 220 and cylinder bores 222. Cylinder block 210 also includes numerous openings 240, 242, 246, and 248, for example, which may be used for bolt attachment or cooling purposes. In a normal engine operation, as is known, cylinder block 210 is mated with a cylinder head (not shown) and bolted together with a seal member, such as 12 or 112, to provide a seal therebetween.

In normal operation and as installed, sealing contact face 20 of seal member 12/112 will form a fluid seal with sealing contact face 220 on cylinder block 210 or a sealing contact face (not shown) on the cylinder head. In normal operation, when a seal is functioning properly, electrically conductive or chemically reactive particulates 16 will be dry and not exposed to the fluid contained in the cylinder block. However, if a leak is initiated, and fluid starts escaping between sealing contact face 20 of seal member 12/112 and sealing contact face 220, the fluid will contact the particulates and carry the particulates to sensing member 14. If conductive particulates are used, as the conductive particulates fill the gap between electric conductors 30 and 32, a short circuit or switching of the circuit will be created so that an alarm or other leak indicator may be activated to provide a notification that a leak has initiated. If reactive particulates are used, as the reactive particulates come into contact with electric conductors 30 and 32, a corrosion or modification of the electric conductors will occur causing a change in the electrical properties or performance of the conductor to change so that an alarm or other leak indicator may be activated to provide a notification that a leak has initiated.

This type of early leak detection capability has the potential to provide significant savings, reduce repair costs, and prevent productivity losses due to damaged engines, as the leak can be repaired before the contained fluid escapes and causes significant damage to the engine.

While the invention has been taught with specific reference to these embodiments, one skilled in the art will recognize that changes can be made in form and detail without departing from the spirit and scope of the invention. The described embodiments are to be considered, therefore, in all respects only as illustrative and not restrictive. As such, the scope of the invention is indicated by the following claims rather than by the description.

1. A seal device with integrated leak detection capability for detecting the initiation of a leak of a contained fluid comprising:
a seal member, including at least one sealing contact surface and a sensing member located on said sealing contact surface, said sensing member detecting if a breach has occurred in a seal formed between said sealing contact surface and a member against which said sealing contact surface is sealed to provide an indication of the breach before a complete breach of the seal occurs; and
a deposit of sense enabling material on said seal member located between the contained fluid and said sensing member.

2. The seal device as set forth in claim 1, wherein said seal member is a header gasket.

3. The seal device as set forth in claim 1, wherein the sense enabling material includes electrically conductive particulates.

4. The seal device as set forth in claim 1, wherein the sense enabling material includes chemically reactive particulates.

5. The seal device as set forth in claim 1, wherein said sense enabling material is mixed with a binder material for deposition on said seal member.

6. The seal device as set forth in claim 5, wherein said binder material breaks down upon contact with the contained fluid.

7. The seal device as set forth in claim 4, wherein said sense enabling material is carried by the contained fluid to contact said sensing member to detect the initiation of a leak of the seal.

8. The seal device as set forth in claim 5, wherein said binder material is removed, while leaving said sense enabling material, prior to installation of said seal member.

9. The seal device as set forth in claim 1, wherein said sense enabling material is mixed with a fluid media prior to deposition on said seal member.

10. The seal device as set forth in claim 9, wherein the fluid media is evaporated from said seal member prior to installation.

11. The seal device as set forth in claim 1, wherein said sensing member includes at least two concentric or adjacent electric conductors.

12. The seal device as set forth in claim 11, wherein said sense enabling material includes conductive particulates that cause a short circuit between said electric conductors when carried by the contained fluid.

13. The seal device as set forth in claim 12, wherein said sense enabling material forms a concentric ring adjacent said electric conductors.

14. The seal device as set forth in claim 12, wherein said sense enabling material forms a concentric ring located between said electric conductors.

15. The seal device as set forth in claim 11, wherein said sense enabling material includes chemically reactive material that corrodes or modifies the electric conductors causing a change in the electrical properties or performance of said electric conductors.

16. A method of providing a seal with integrated leak detection capability for detecting the initiation of a leak of a contained fluid comprising the steps of:
providing a fluid carrying member for containing the fluid and a sealing contact face on said fluid carrying member configured to form a seal with another member;
providing a seal member, including a contact face configured to seal against said contact face of said fluid carrying member, and
providing a sensing member located on said contact face of said seal member;
providing a deposit of sense enabling material on said contact face of said seal member;
forming a seal between said sealing contact surfaces of said seal member and said contact face of said fluid carrying member, wherein when said seal is intact, said sensing member and said deposit of sense enabling material are not in contact with the contained fluid in said fluid carrying member; and
sensing the initiation of a leak of said seal by the contained fluid carrying said sense enabling material into contact with said sensing member.

17. The method of providing a seal with integrated leak detection capability as set forth in claim 16, further including the steps of providing a binder and mixing said binder with said sense enabling material for deposition on said seal member.

18. The method of providing a seal with integrated leak detection capability as set forth in claim 17, wherein said binder material breaks down upon contact with the contained fluid.

19. The method of providing a seal with integrated leak detection capability as set forth in claim 16, wherein said sense enabling material is carried by the contained fluid to contact said sensing member to detect the initiation of leak of the seal.

20. The method of providing a seal with integrated leak detection capability as set forth in claim 16, further including the steps of providing a fluid media and mixing the fluid media with said sense enabling material prior to deposition on said seal member.

21. The method of providing a seal with integrated leak detection capability as set forth in claim 20, further including the step of evaporating the fluid media from said seal member prior to installation.

22. The method of providing a seal with integrated leak detection capability as set forth in claim 16, wherein said sensing member includes at least two concentric or adjacent electric conductors.

23. The method of providing a seal with integrated leak detection capability as set forth in claim 22, wherein said sense enabling material includes conductive particles, and the method further includes the step of creating a short circuit between said electric conductors when said conductive particles are carried by the contained fluid.

24. The method of providing a seal with integrated leak detection capability as set forth in claim 16, wherein said sense enabling material includes chemically reactive particulates and the sensing member includes at least one electrical conductor, and the method further includes the step of creating a change in conductivity of the electrical conductor when the chemically reactive particles are carried by the contained fluid and change the conductivity in the electrical conductor.
